(19) United States
(12) Patent Application Publication
(10) Pub. No.: US 2011/0093688 A1
(43) Pub. Date: Apr. 21, 2011

(54) CONFIGURATION MANAGEMENT APPARATUS, CONFIGURATION MANAGEMENT PROGRAM, AND CONFIGURATION MANAGEMENT METHOD

(75) Inventors: Yuji Wada, Kawasaki (JP); Masazumi Matsubara, Kawasaki (JP); Kenji Morimoto, Tokyo (JP); Akira Katsuno, Kawasaki (JP); Yasuhide Matsumoto, Kawasaki (JP); Hiroshi Otsuka, Kawasaki (JP)

(73) Assignee: FUJITSU LIMITED, Kawasaki-shi (JP)

(21) Appl. No.: 12/973,546

(22) Filed: Dec. 20, 2010

Related U.S. Application Data
(63) Continuation of application No. PCT/JP2008/061524, filed on Jun. 25, 2008.

(51) Int. Cl. G06F 9/00

(52) U.S. Cl. 713/1

(57) ABSTRACT

A configuration management apparatus that manages, on the basis of data having configuration items and attribute information defining the configuration items, information about the resources includes: an operation execution unit that acquires a processing request that at least includes attribute information and processing information; a processing execution unit that determines for which configuration item the processing request is made and links the configuration item and the processing request; and a delay calculation determination unit, a calculation execution unit and a delay calculation plan unit that perform a process of processing information inside the processing request for the configuration item on the basis of the linking by the processing execution unit at a different timing from a timing when the processing request is acquired by the operation execution unit to get attribute information inside the processing request reflected in the configuration item.

### CROSS-REFERENCE TO RELATED APPLICATIONS

This application is a continuation application, filed under 35 U.S.C. §111(a), of PCT Application No. PCT/JP2008/061524, filed Jun. 25, 2008, the disclosure of which is herein incorporated in its entirety by reference.

### FIELD

The present invention relates to a configuration management apparatus, a configuration management program and a configuration management method that manage information about resources.

### BACKGROUND

A configuration management system that enables data to be shared between different systems that store a large amount of data (referred to as a FCMDB system (FCMDB: Federated Configuration Management Database), hereinafter) is known.

For example, the FCMDB system manages the configuration of resources by registering, updating, retrieving and deleting information about resources that make up a variety of systems, such as a business operation system or analysis system, which include a plurality of computers. FIG. 13 is a schematic diagram of a FCMDB system. For example, the FCMDB system acquires a configuration item (referred to as CI, hereinafter), which is each of the items that make up the FCMDB system, and attribute information (referred to as a property, hereinafter), which defines an CI, from different systems, which each manage configuration information, incident information, trouble information, release information, change information and application information. The FCMDB system retains the relationship between the CIs. Therefore, pieces of information retained by different business systems are linked to each other; the information between different systems is managed.

Accordingly, in addition to a typical DB (Database) function, the FCMDB system carries out a reconciliation, which is a process of linking Entities (which are a general term for CI, property and relationship) and manipulating the property of the corresponding Entity in order to make adjustments to and ensure consistency of the information retained by different systems.

What is disclosed as a related conventional technique is a disc control device that efficiently accesses while satisfying an allowable delay time required for data to be output after a read request occurs.

### [Patent Document 1] Japanese Laid-open Patent Publication No. 08-55055

Since reconciliation takes place as described above, the process of the FCMDB system takes more time than a typical DB process does. Meanwhile, some of requests for processing from users need to be completed as soon as possible, while some may take relatively longer time to be completed.

When a retrieval request is made to the FCMDB system, the retrieval results from the FCMDB system needs to be accurate, not inconsistent or old information.

### SUMMARY

According to an aspect of the invention, there is provided a configuration management apparatus that manages, on the basis of data having configuration items that are information representing resources that make up a system and attribute information defining the configuration items, information about the resources, the apparatus including: a processing request acquisition unit that acquires a processing request that at least includes attribute information and processing information about which process, registration, update or deletion of the attribute information, is to be performed; a linking unit that determines, when a processing request is acquired by the processing request acquisition unit, for which configuration item the processing request is made and links the configuration item and the processing request; and an attribute information reflection unit that performs a process of processing information inside the processing request for the configuration item on the basis of the linking by the linking unit at a different timing from a timing when the processing request is acquired by the processing request acquisition unit to get attribute information inside the processing request reflected in the configuration item.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the configuration of a FCMDB system according to an embodiment;

FIG. 2 is a diagram illustrating an example of an overview of a delay process according to the embodiment;

FIG. 3 is a flowchart illustrating an example of a process in which the FCMDB system acquires a processing request from a client terminal;

FIG. 4 is a flowchart illustrating an example of a process of a processing execution unit;

FIG. 5 is a diagram illustrating an example of a priority determination information table as well as an example of an overview of a process of the processing execution unit;

FIG. 6 is a flowchart illustrating an example of a process of a calculation execution unit;

FIG. 7 is a diagram (general overview) illustrating an example of an overview of a process of the calculation execution unit;

FIG. 8 is a diagram (before execution of calculation) illustrating an example of an overview of a process of the calculation execution unit;

FIG. 9 is a diagram (after execution of calculation) illustrating an example of an overview of a process of the calculation execution unit;

FIG. 10 is a flowchart illustrating an example of a process of a delay calculation determination unit;

FIG. 11 is a flowchart illustrating an example of a process of the delay calculation determination unit;

FIG. 12 is a diagram illustrating an example of a delay process by the delay calculation determination unit and a delay calculation plan unit; and

FIG. 13 is a diagram illustrating an overview of a FCMDB system.

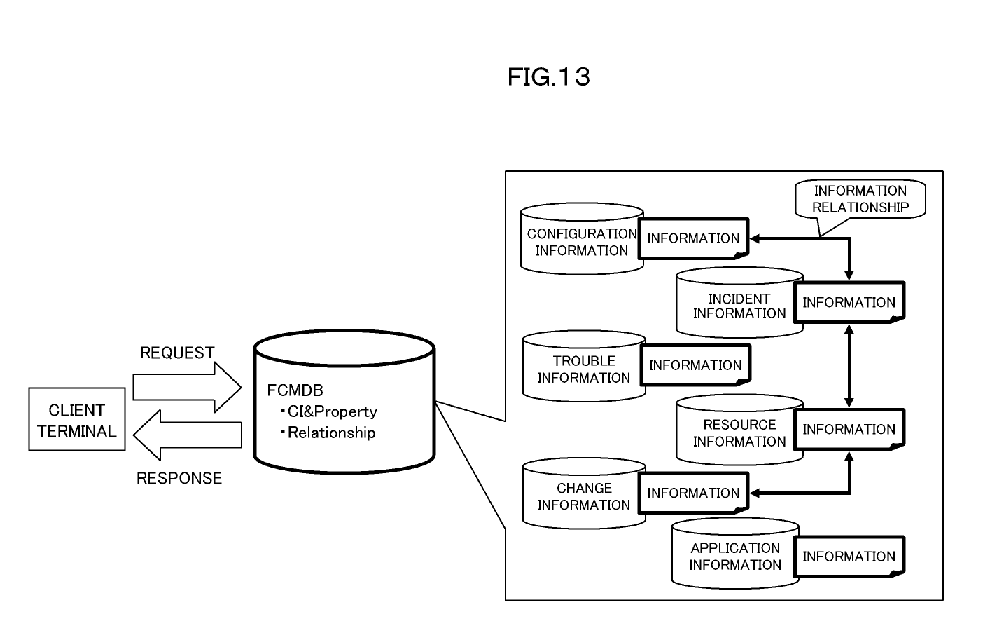

### DESCRIPTION OF EMBODIMENT

Hereinafter, the embodiment will be described with reference to the accompanying drawings.

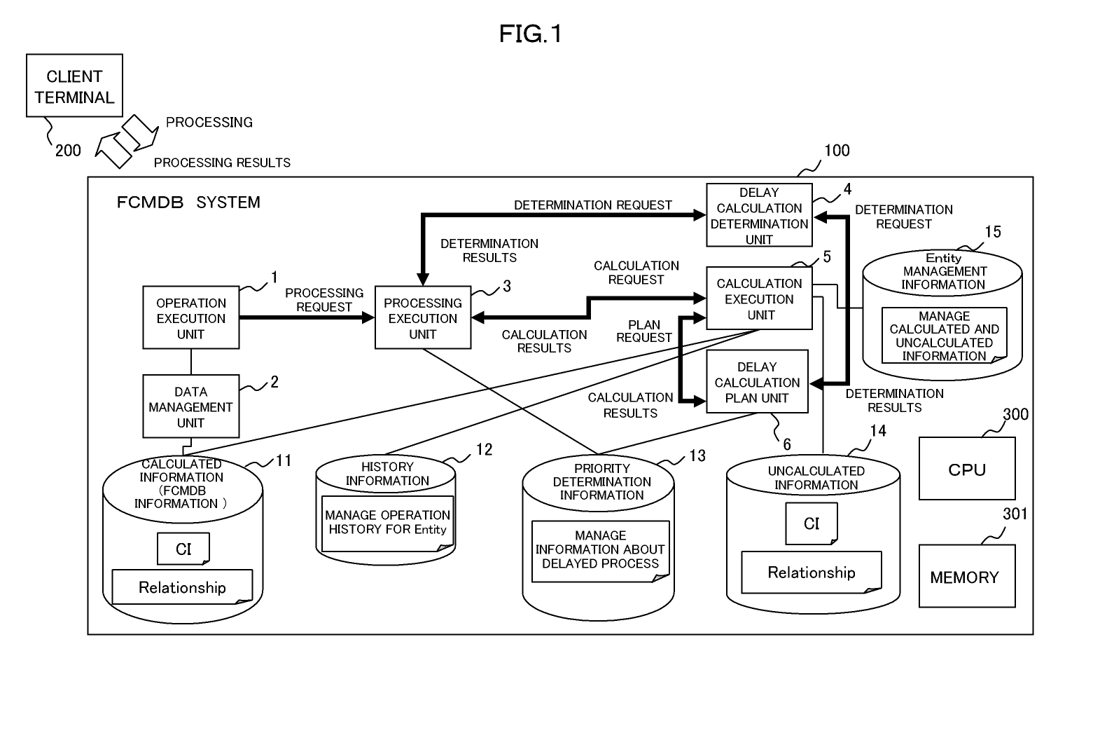

FIG. 1 illustrates a FCMDB system according to the present embodiment. The FCMDB system 100 is equipped with an operation execution unit 1, a data management unit 2, a processing execution unit 3, a delay calculation determination unit 4, a calculation execution unit 5 and a delay calculation plan unit 6. The FCMDB system 100 is also equipped with a calculated information DB11, a history information table 12, a priority determination information table 13, an uncalculated information DB14 and an Entity management information table 15.

A conventional FCMDB system is realized by the operation execution unit 1 and the data management unit 2. The operation execution unit 1 acquires a processing request for registration, deletion, update or retrieval from a client terminal 200, a terminal used by a user. The operation execution unit 1 instructs the data management unit 2 to access FCMDB information. The data management unit 2 performs the reading or writing of the calculated information DB11 (FCMDB information).

Moreover, the operation execution unit 1 of the present embodiment acquires from the client terminal 200 a processing request that consists of: a processing type that indicates which process, retrieval, registration, deletion or update, is to be executed; and information that represents the specific details of a process (conditional expressions for retrieval, actual data and the like). In addition, the operation execution unit 1 acquires a desired completion time that is when the processing request is completed. The operation execution unit 1 transmits the acquired processing type, information and desired completion time to the processing execution unit 3 as a processing request. Incidentally, if the processing request needs calculation to be carried out as soon as possible, the desired completion time is set at 0.

The processing execution unit 3 acquires the processing request from the operation execution unit 1. On the basis of which processing type, retrieval, registration, deletion or update, is specified in the processing request, the processing execution unit 3 makes a processing execution request to the delay calculation determination unit 4 and the calculation execution unit 5. The processing execution unit 3 also acquires the execution results of the calculation determination unit 4 and the calculation execution unit 5. If the processing request can be delayed, the processing execution unit 3 registers the details of the request in the priority determination information table 13.

When the processing request is for registration, deletion or update, the delay calculation determination unit 4 makes a determination as to whether an operation of causing a property to be reflected in the corresponding CI needs to be performed as soon as possible (Hereinafter, the operation of causing a property to be reflected in the corresponding CI is referred to as “calculation”, hereinafter) on the basis of the frequency of update of data, the desired completion time from a user, and the like.

The calculation execution unit 5 calculates in response to the processing type of the processing request acquired by the processing execution unit 3.

The delay calculation plan unit 6 acquires the details of the request kept by the priority determination information table 13 and asks the delay calculation determination unit 4 to make a delay determination. When the delay determination results by the delay calculation determination unit 4 indicate that it is impossible to delay, the delay calculation plan unit 6 asks the calculation execution unit 5 to calculate.

The calculated information DB11, which is the same configuration management DB as a conventional one, retains Entities (referred to as calculated information, hereinafter) whose properties have been calculated. The history information table 12 keeps information about a history of Entities. The following factors are linked to each other on the history information table 12: an Entity type representing CI or Relationship, the average frequency of update (a numerical value representing the number of times updating is performed on a daily or weekly basis, for example) that is an indicator of the frequency of update for Entities, the average existence time that is an indicator of a period during which data is retained as an Entity, and the like.

The priority determination information table 13 is a table where, as the details of processing requests, the following factors are linked to each other: an identifier (id) that is assigned to each processing request, the processing type of a processing request, and the desired completion time. Incidentally, the data kept by the priority determination information table 13 is written by the processing execution unit 3 and used by the delay calculation plan unit 6.

The uncalculated information DB14 retains information (referred to as uncalculated information, hereinafter) for which a CI has been already linked but a property is not calculated yet. The Entity management information table 15 is a table for managing whether an Entity is calculated or not.

Incidentally, each of the above tables and DBs will be described later in detail.

Each of the above units is realized by the following components working together: a CPU 300 (CPU: Central Processing Unit) installed in the FCMDB system, hardware resources such as a memory 301 that is a storage device, and programs stored in advance in the memory 301. Suppose each of the above tables and DBs is retained in a processing area of the memory 301.

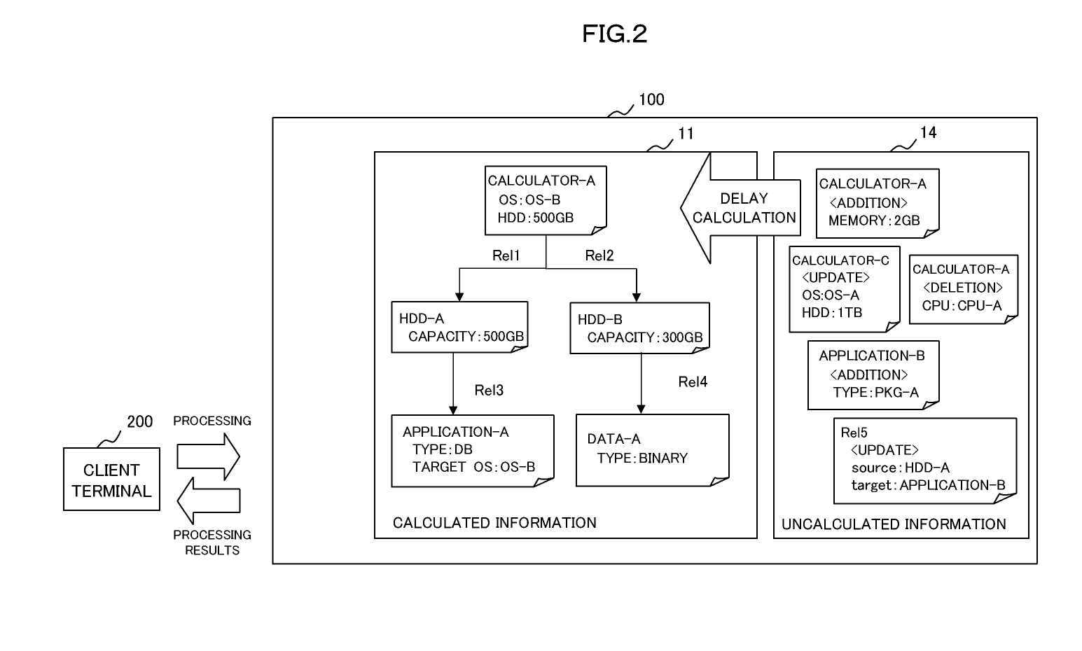

A conceptual diagram of FIG. 2 illustrates an example of the calculated information kept by the calculated information DB11 and the uncalculated information kept by the uncalculated information DB14. The following describes an overview of a process that uses the calculated and uncalculated information of the FCMDB system 100.

In FIG. 2, the following CIs are kept by the calculated information DB11: “Calculator-A,” “HDD-A,” “HDD-B,” “Application-A,” and “Data-A.” The relationship (represented by ReIX (X: item number) in FIG. 2) between the CIs is kept by the calculated information DB11 as calculated information. The calculated information DB11 also retains the calculated properties of the CIs. Incidentally, in the case of FIG. 2, the calculated properties of the CI of Calculator-A are for example “OS: OS-B” and “HDD: 500 GB”. The calculated property of the CI of HDD-A is “Capacity: 500 GB.”

Meanwhile, in the uncalculated information DB14, only the linking to the CIs kept by the calculated information DB11 is performed; a property and processing type that are not calculated for the CIs are kept. In FIG. 2, for example, the CI is linked to “Calculator-A” kept by the calculated information DB11. However, “Memory: 2 GB,” a property that is not calculated for “Calculator A”, and registration (addition), a processing type, are kept by the uncalculated information DB14. In another example, the information with a processing type of deletion and a property of “CPU: CPU-A” for the CI of “Calculator-A” is kept by the uncalculated information DB14.

The FCMDB system 100 of the present embodiment delays a calculation process by performing the linking of the CIs at a time when a processing request is made by the client terminal 200 and calculating the properties of the CIs at a different timing from when the processing request is made (at a time when it is possible to complete by the desired completion time specified by a user, for example). In this manner, the FCMDB system 100 makes the processing time look shorter, compared with the case in which the linking of CIs and calculation of properties are performed at a time when a processing request is made as in a conventional FCMDB system.

When a retrieval request is made by the client terminal 200, it is preferable for the FCMDB system 100 not to inform the client terminal 200 the inaccurate retrieval results that occur due to the existence of uncalculated properties. Therefore, when a processing request for retrieval is made, the FCMDB system 100 gets the following property reflected at a timing when the processing request for retrieval is acquired: the uncalculated property of a CI to which a retrieval process is applied.

The following describes a process of the FCMDB system 100.

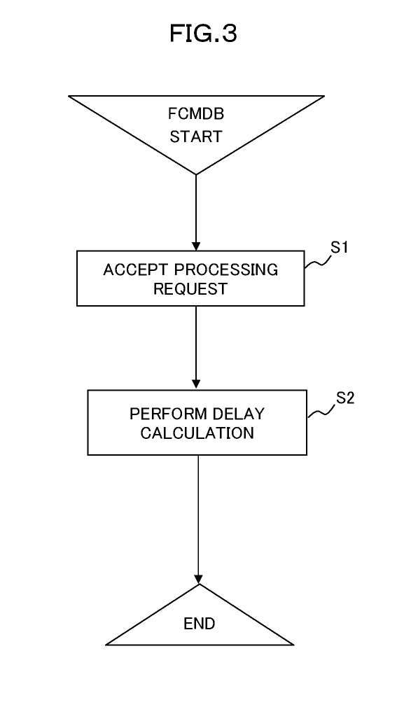

FIG. 3 illustrates a process in which the FCMDB system 100 acquires a processing request from the client terminal 200. The operation execution unit 1 acquires a processing request from the client terminal 200 (Step S1). Incidentally, the processing request acquired from the client terminal 200 includes: a processing type that indicates which process, retrieval, update, registration or deletion, is to be executed; information about conditional expressions for retrieval as well as about actual data and the like for registration, update and deletion processes; and a desired completion time that is when the requested process is to be completed. Hereinafter, if needed, the processing type is referred to as “processing type o” or simply “o.” The information about conditional expressions for retrieval as well as about actual data and the like for registration, update and deletion processes is referred to as “information d” or simply “d” if needed. The desired completion time is referred to as “desired completion time t” or simply “t” if needed.

Then, the FCMDB system 100 uses each of the above units to perform a delay calculation process (Step S2).

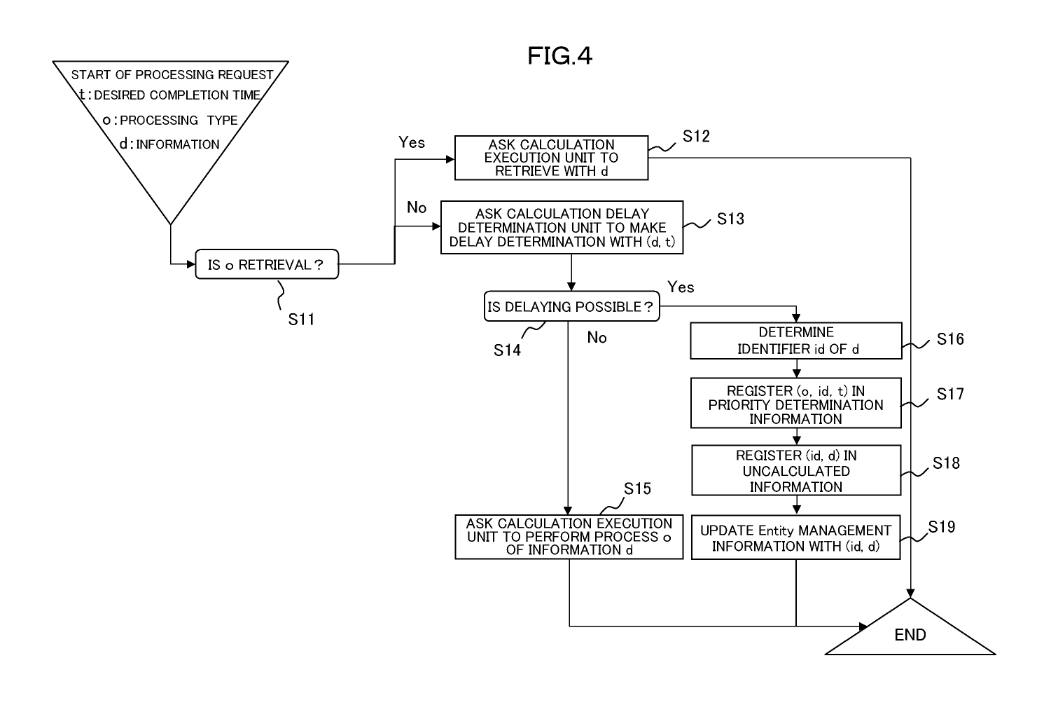

The following describes in detail the delay calculation process of step S2 on the basis of the process of each unit. First, a process of the processing execution unit 3 will be described with reference to a flowchart of FIG. 4.

The processing execution unit 3 acquires a processing request, a request from the operation execution unit 1, and makes a determination as to whether the processing type o is retrieval (Step S11). When the processing type o is retrieval (Step S11, Yes), the processing execution unit 3 asks the calculation execution unit 5 to retrieve with information d (Step S12). Then, the process of the processing execution unit 3 ends.

Meanwhile, when the processing type is for the process of update, registration or deletion, not retrieval (Step S11, No), the processing execution unit 3 asks the delay calculation determination unit 4 to make a delay determination on the basis of the information d and the desired completion time t (Step S13). When it is determined by the delay calculation determination unit 4 that it is possible to delay (Step S14, Yes), the processing execution unit 3 determines an identifier (referred to as identifier id, hereinafter) for the information d of the processing request (Step S16) and registers the processing type o, the identifier id and the desired completion time t in the priority determination information table 13 (Step S17). The processing execution unit 3 also registers in a predetermined area of the uncalculated information DB14 the identifier id and the information d (Step S18).

Then, the processing execution unit 3 updates the Entity management information table 15 (described later in detail) with the identifier id and the information d (Step S19) before the process ends.

Incidentally, when it is determined by the delay calculation determination unit 4 that it is not possible to delay (Step S14, No), the processing execution unit 3 requests the calculation execution unit 5 to calculate by transmitting the processing type o and the information d (Step S15).

Incidentally, before executing the flowchart of FIG. 4 (i.e. before step S11), the processing execution unit 3 may make a determination as to which CI the processing type o and the information d are intended for (The determination process uses a function (a function of the operation execution unit 1, for example) included in a conventional FCMEB system) and link the CI and the processing request.

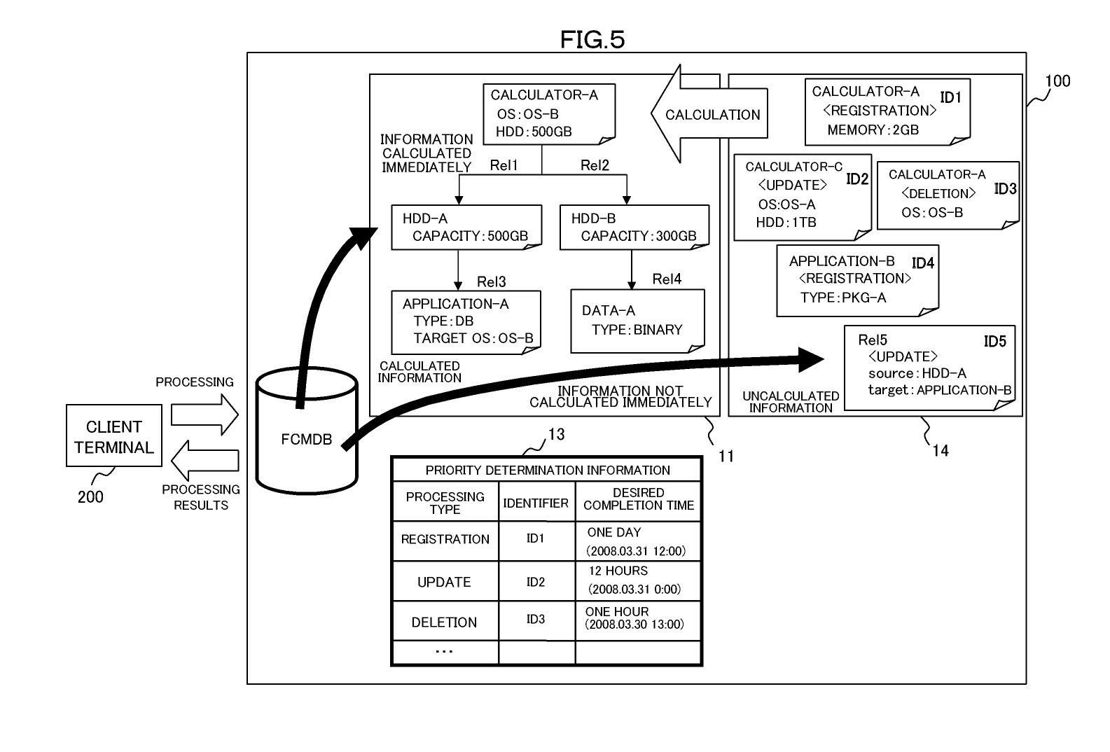

FIG. 5 illustrates an example of the priority determination information table 13 and an overview of a process of the processing execution unit 3. When the processing request is update, registration or deletion as a result of the process of the processing execution unit 3 illustrated in FIG. 4, the FCMDB system 100 promptly calculates a property for the processing request that needs to be calculated as soon as possible and stores in the calculated information DB11. Meanwhile, as for the processing request that can be delayed because it is not preferable to calculate the processing request as soon as possible, the FCMDB system 100 allows the uncalculated information DB14 to retain the processing request to which the identifier id is being attached. The FCMDB system 100 also registers the details (the processing type o, the identifier id and the desired completion time t) of the processing request in the priority determination information table 13.

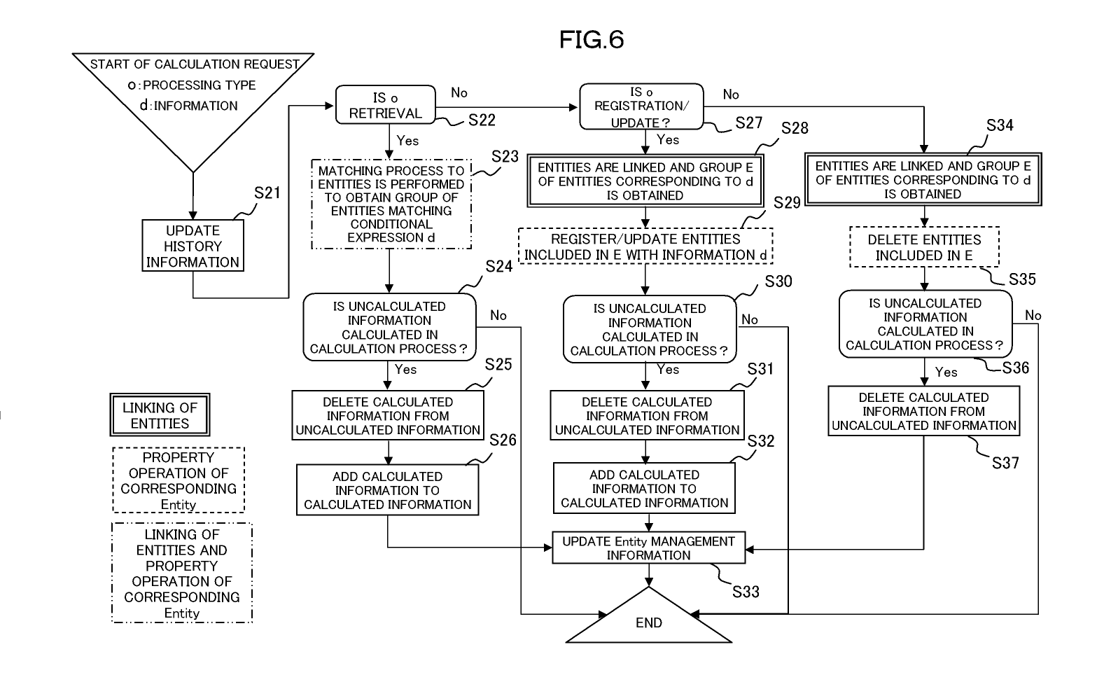

The following describes the process of the calculation execution unit 5 with reference to a flowchart of FIG. 6. Incidentally, in FIG. 6, the processing steps indicated by double lines are processing steps indicating a process of linking Entities (CIs). The processing steps indicated by dotted lines are processing steps indicating that properties are calculated. The processing steps indicated by long dashed double-dotted lines are processing steps indicating that the linking of Entities and the calculation of the corresponding properties are carried out.

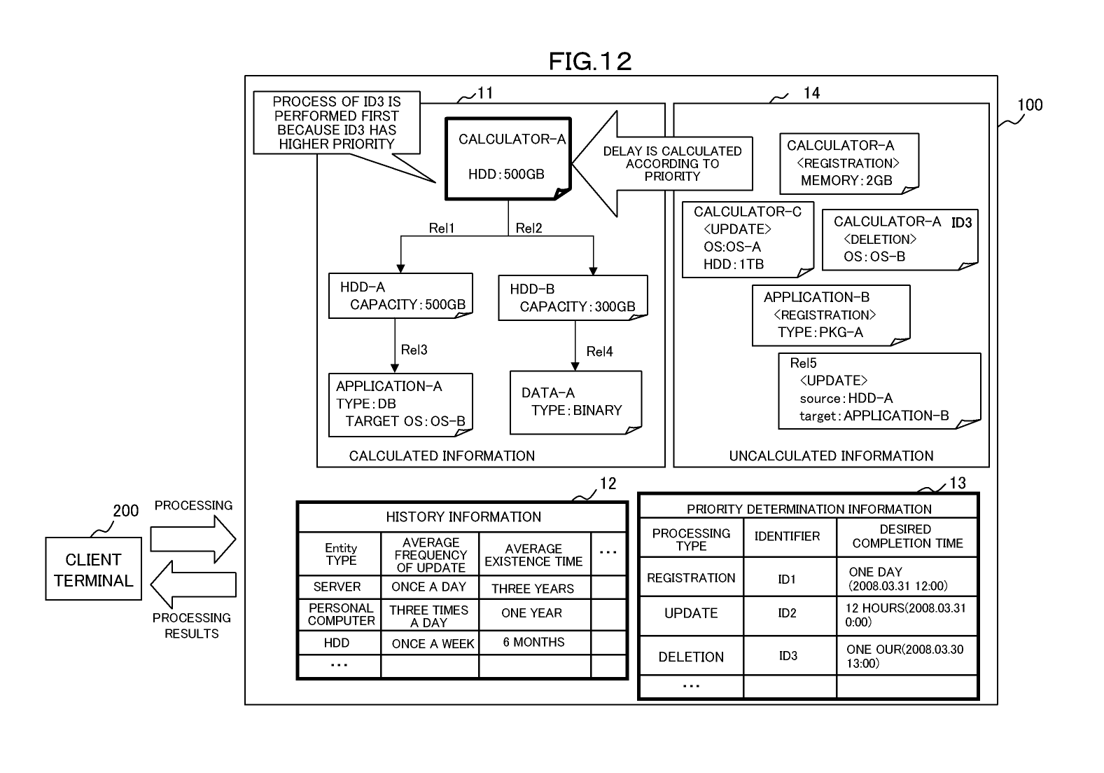

The calculation execution unit 5 first updates the information retained by the history information table 12 on the basis of the processing type o and the information d (Step S21). For example, when the processing type o is retrieval, the average frequency of update of the Entity type of the information d is updated. When the processing type o is update, registration or deletion, the average existence time of the Entity type of the information d is updated (Incidentally, see FIG. 12 for an example of the history information table 12).

Then, the calculation execution unit 5 makes a determination as to the processing type o. When the processing type o is retrieval (Step S22, Yes), the calculation execution unit 5 performs a matching process to Entities to obtain a group of Entities that match the information d (a conditional expression in this case) (Step S23).

The calculation execution unit 5 then makes a determination in the process of step S23 as to whether a property retained as uncalculated information has been calculated (Step S24). When the property retained as uncalculated information has been calculated (Step S24, Yes), the calculation execution unit 5 deletes information about the calculated property from the uncalculated information DB14 (Step S25) and adds the calculated property to the calculated information DB11 (Step S26). Based on the processes performed by the deletion process (Step S25) and the addition process (Step S26), the calculation execution unit 5 updates the Entity management information (Step S33) before the process ends.

Meanwhile, when it is found in the process of determining whether the property retained as uncalculated information has been calculated that the calculation has not been performed (Step S24, No), the process ends.

The following explains the determination process of step S22. When the processing type o is not retrieval (Step S22, No), the calculation execution unit 5 makes a determination as to whether the processing type o is registration or update (Step S27). When the processing type o is registration or update (Step S27, Yes), the calculation execution unit 5 links the Entities and obtain a group E of Entities corresponding to the information d (Step S28).

The calculation execution unit 5 performs a registration or update process for the Entities included in the Entity group E with the information d (Step S29).

The calculation execution unit 5 then makes a determination in the process of step S29 as to whether a property retained as uncalculated information has been calculated (Step S30). When the property retained as uncalculated information has been calculated (Step S30, Yes), the calculation execution unit 5 deletes information about the calculated property from the uncalculated information DB14 (Step S31) and adds the calculated property to the calculated information DB11 (Step S32). Based on the processes performed by the deletion process (Step S31) and the addition process (Step S32), the calculation execution unit 5 updates the Entity management information (Step S33) before the process ends.

Meanwhile, when it is found in the process of determining whether the property retained as uncalculated information has been calculated that the calculation has not been performed (Step S30, No), the process ends.

The following explains the determination process of step S27. When the processing type o is not registration or update (Step S27, No), the calculation execution unit 5 considers the processing type o to be a deletion process. The calculation execution unit 5 performs the linking of the Entities and obtains the Entity group E corresponding to the information d (Step S34). The calculation execution unit 5 deletes Entities included in the Entity group E (Step S35).

The calculation execution unit 5 then makes a determination as to whether uncalculated information has been calculated in the process of step S35 (Step S36). When uncalculated information has been calculated (Step S36, Yes), the calculation execution unit 5 deletes the calculated information from the uncalculated information DB14 (Step S37). Based on the process performed by the deletion process (Step S37), the calculation execution unit 5 updates the Entity management information (Step S33) before the process ends.

Meanwhile, when it is found in the process of determining whether uncalculated information has been calculated that the calculation has not been performed (Step S36, No), the process ends.

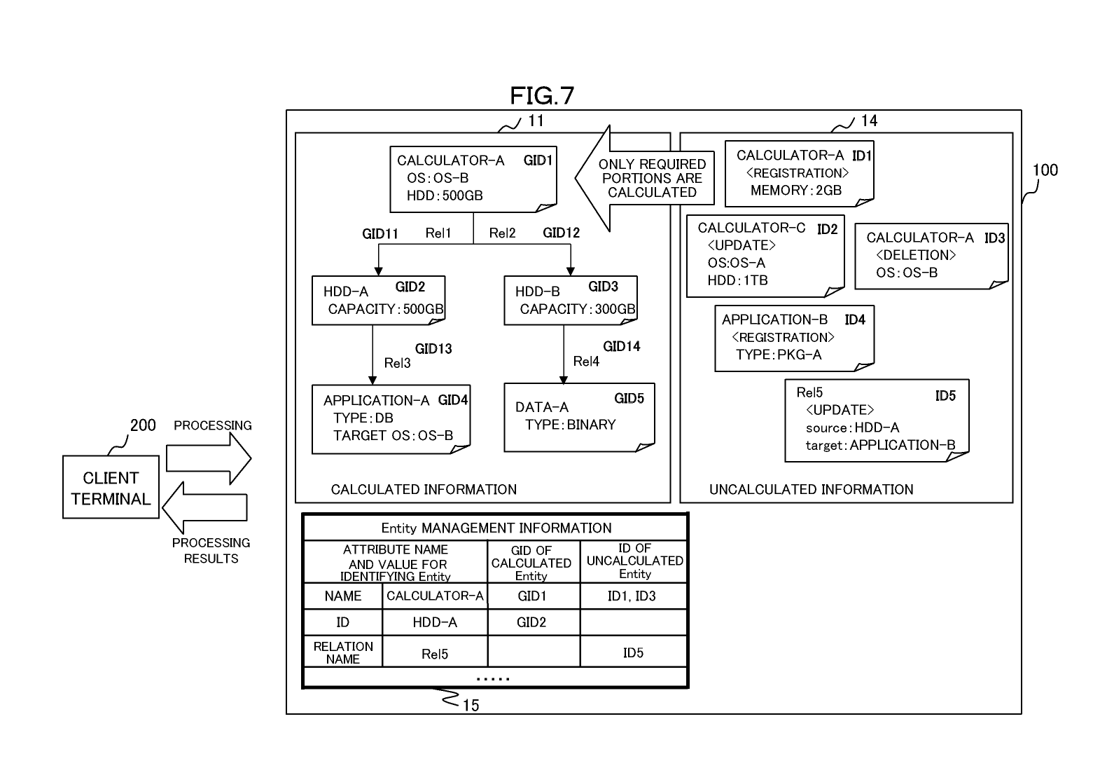

FIGS. 7 to 9 illustrate an overview of the process of the above calculation execution unit 5.

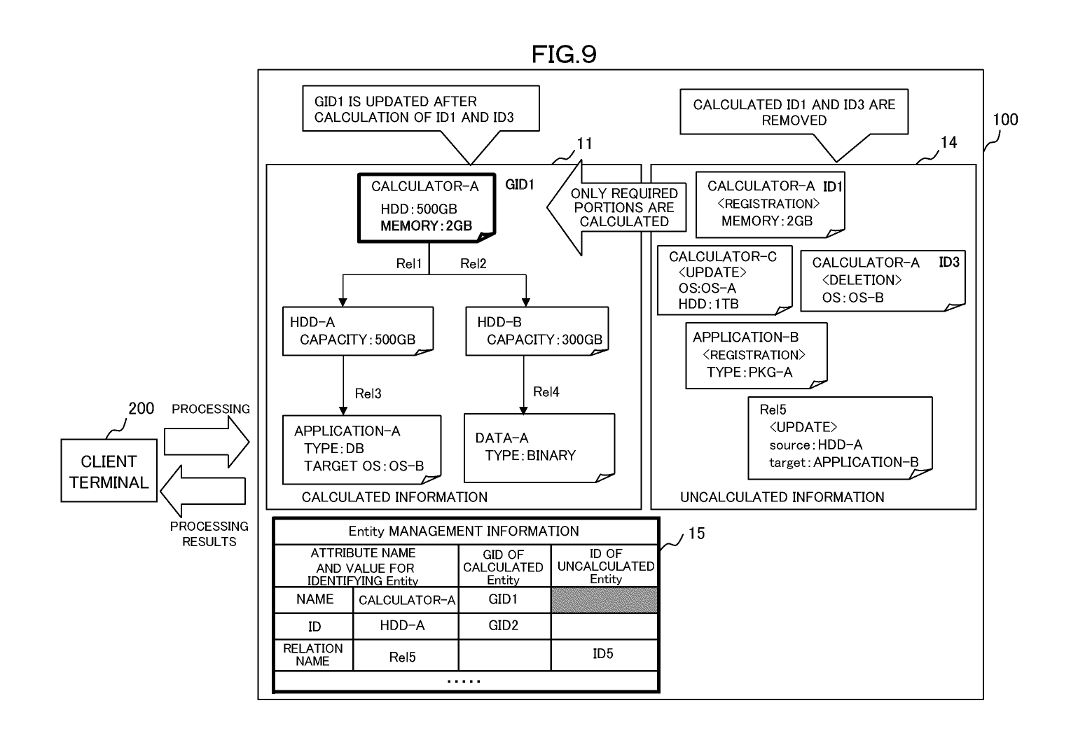

FIG. 7 illustrates a general overview. The FCMDB system 100 keeps the Entity management information table 15. The Entity management information table 15 keeps the following factors for each Entity (an attribute name and attribute value for identifying an Entity) as Entity management information: a group ID (GID), or identification information corresponding to a calculated Entity (which is represented by “GIU of a calculated Entity” in FIG. 9); and an identifier id (which is represented by “ID of an uncalculated Entity” in FIG. 9). For example, in the case of FIG. 7, GID1, as GID, is assigned to the Entity of “Calculator-A” for an attribute name of the Entity. Moreover, as uncalculated information linked to the Entity of Calculator-A, ID1 (whose processing type o and information d are registration and “Memory: 2 GB,” respectively) and ID3 (whose processing type o and information d are deletion and “OS: OS-B,” respectively) are linked.

Similarly, GID2 is assigned to the Entity of HDD-A. However, since there is no uncalculated information for the Entity of HDD-A, an identifier id is not linked. Moreover, the Entity of Re15 is not registered yet. Since the Entity of Re15 is not calculated information, a GID is not assigned. An identifier id (ID5) is linked as uncalculated information to the Entity of Re15.

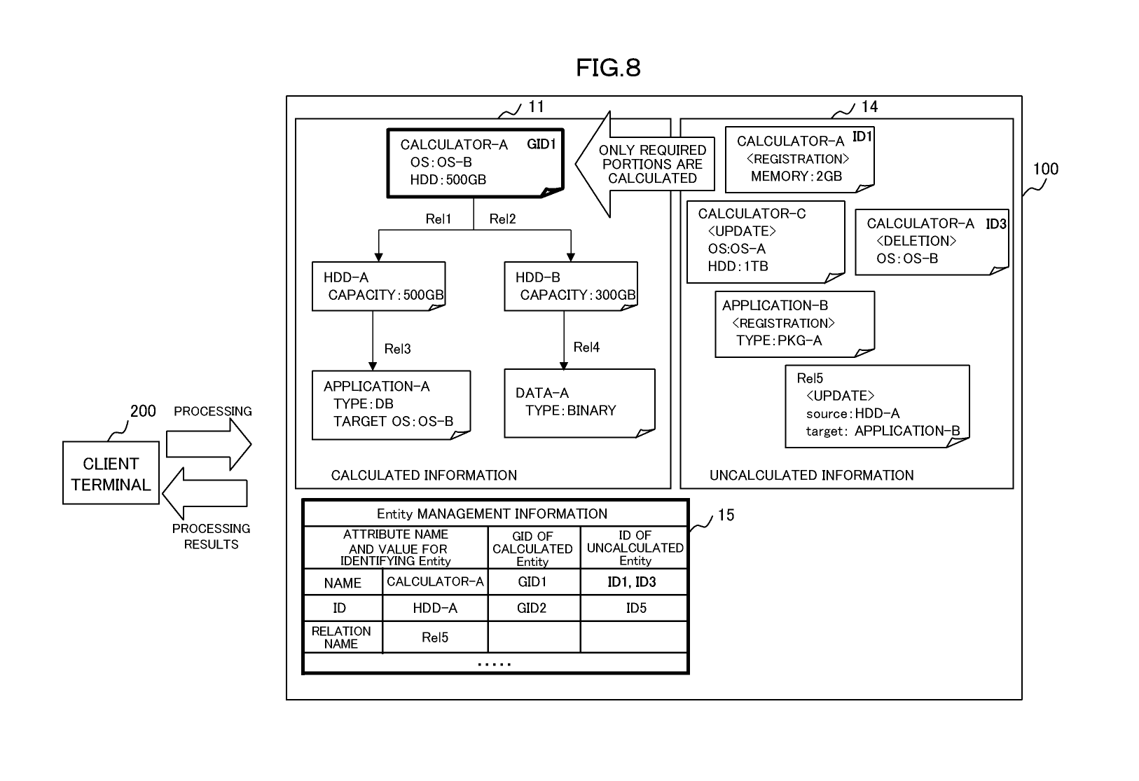

FIG. 8 illustrates an example of a state before a calculation process of the calculation execution unit 5. As illustrated in FIG. 8, for example, when it is preferable to calculate information about GID1 (i.e. Calculator-A) as a result of a processing request from the client terminal 200, the calculation execution unit 5 refers to the Entity management information table 15 and therefore determines that it is preferable to calculate ID1 and ID3 as uncalculated information pertaining to GID1.

The calculation execution unit 5 mergers (calculates) the ID1 and ID2 into calculated information, thereby updating “Calculator-A” of GID1 that is calculated information. For example, in the case of FIG. 8, the properties of “Calculator-A” are “OS: OS-B” and “HDD: 500 GB.” After the calculation process, as illustrated in FIG. 9, since the calculation of ID1 and ID3 are performed, the properties of “Calculator-A” are updated to represent “HDD: 500 GB” and “Memory: 2 GB.” Moreover, the calculated ID1 and ID3 are removed from the uncalculated information. Then, the calculation execution unit 5 deletes the value of the identifier id (the ID of the uncalculated Entity) in the Entity management information table 15.

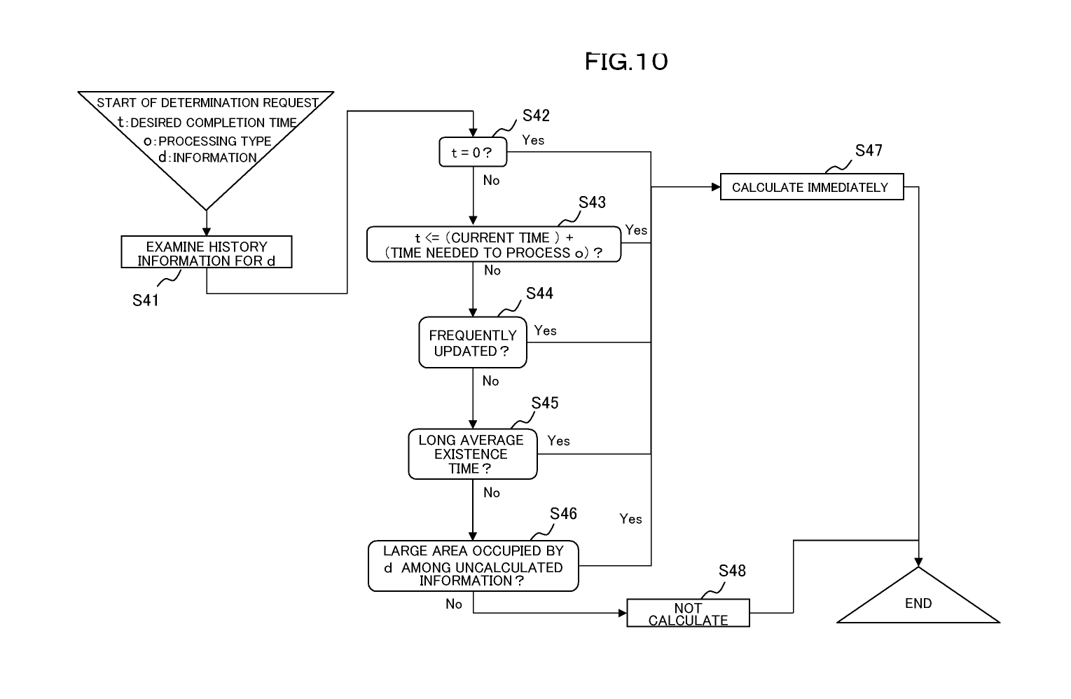

The following describes a process of the delay calculation determination unit 4 with reference to a flowchart of FIG. 10.

After acquiring a determination request from the processing execution unit 3 or delay calculation plan unit 6, the delay calculation determination unit 4 identifies the Entity type of the information d and examines history information of the Entity type retained by the history information table 12 (Step S41).

Then, the delay calculation determination unit 4 makes a determination as to whether the desired completion time t is 0 (Step S42) as well as whether the time obtained by adding the current time and the time needed to perform the calculation process is greater than or equal to the desired completion time t (Step S43). The delay calculation determination unit 4 also makes a determination as to whether the average frequency of update of the Entity type exceeds a predetermined criterion, thereby making a determination as to whether the Entity type is frequently updated (Step S44). Moreover, the delay calculation determination unit 4 makes a determination as to whether the average existence time of the Entity type exceeds a predetermined criterion, thereby making a determination as to whether the Entity type exists for a long period of time (Step S45).

Furthermore, the delay calculation determination unit 4 makes a determination, as a process of preventing the shortage of the capacity of the storage area in advance, as to whether the area occupied by the data size of the properties included in the information d is large in the memory area where the uncalculated information is kept (Step S46). For example, the delay calculation determination unit 4 makes a determination as to whether the ratio of the data size of the properties included in the information d and the storage capacity that can be kept by the uncalculated information DB12 is greater than a predetermined value.

When any of the determinations from step S42 to step S46 is met, the delay calculation determination unit 4 determines that the calculation request may be calculated immediately (It is impossible to delay) (Step S47). Meanwhile, when any of the determinations from step S42 to step S46 is not met, the delay calculation determination unit 4 determines not to calculate (It is possible to delay) (Step S48).

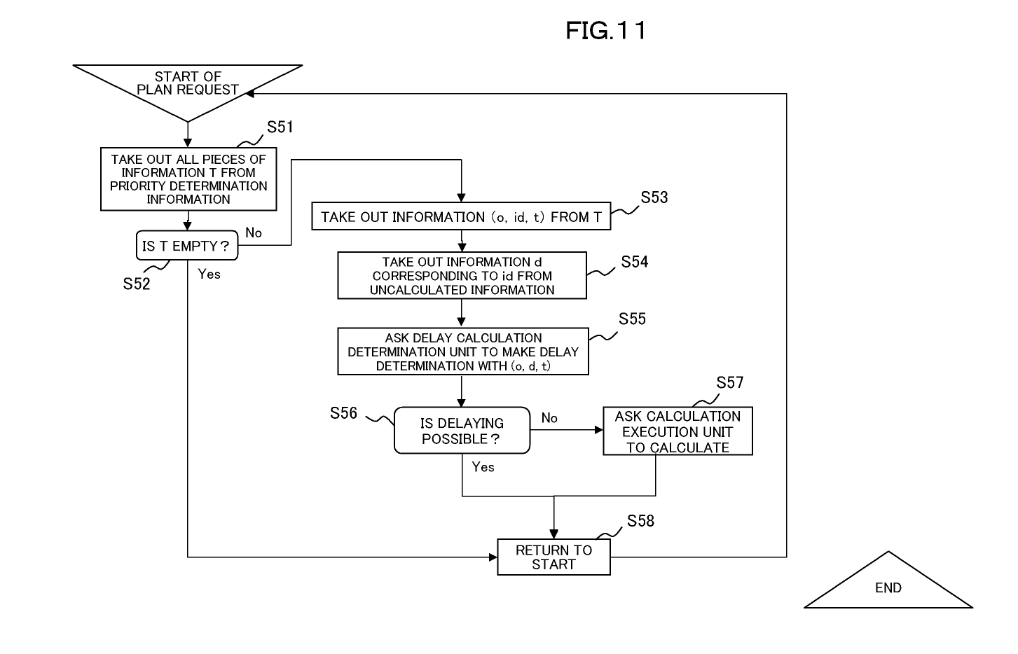

The following describes a process of the delay calculation plan unit 6 with reference to a flowchart of FIG. 11.

The delay calculation plan unit 6 acquires all pieces of information (referred to as information T) from the priority determination information table 13 (Step S51). When the information T is empty (Step S52, Yes), the process returns to “START of plan request.” Then, the process of step 51 is repeated again (Step S58).

When the information T is not empty (Step S52, No), the delay calculation plan unit 6 takes out the processing type o, the identifier id and the desired completion time t from the information T (Step S53) and the information d corresponding the identifier id from the uncalculated information DB14 (Step S54).

The delay calculation plan unit 6 requests the delay calculation determination unit 4 to make a delay determination with the use of the processing type o, the information d and the desired completion time t (Step S55). When the determination results acquired from the delay calculation determination unit 4 indicate that it is possible to delay (Step S56, Yes), the delay calculation plan unit 6 does not do anything and the process returns to “START of plan request” (Step S58). Then, the process of step S51 is repeated again. Meanwhile, when the determination results acquired from the delay calculation determination unit 4 indicate that it is impossible to delay (Step S56, No), the delay calculation plan unit 6 requests the calculation execution unit 5 to calculate (Step S57) and the process returns to “START of plan request” (Step S58).

FIG. 12 illustrates an example of information kept by the priority determination information table 13 and the history information table 12. The following describes a delay process performed by the delay calculation determination unit 4 and the delay calculation plan unit 6.

The priority determination information table 13 is a table where the values of the processing type o, the identifier id and the desired completion time t are retained. The history information table 12 is a table where the values of the Entity type, the average frequency of update and the average existence time are kept. The delay calculation determination unit 4 refers to the values kept by the history information table 12. The delay calculation determination unit 4 also indirectly refers to the desired completion time kept by the priority determination information table 13 through the delay calculation plan unit 6. Therefore, the process of the flowchart illustrated in FIG. 10 is performed. Based on the information held by the priority determination information table 13 and the results of determination by the delay calculation determination unit 4, the delay calculation plan unit 6 determines whether to make a calculation request to the calculation execution unit 5.

In the example of FIG. 12, based on the desired completion time kept by the priority determination information table 13, the delay calculation plan unit 6 determines that the process of ID3 is prioritized and performed at the earliest time. Accordingly, the delay calculation plan unit 6 performs the process of ID3 prior to the processes of ID1 and ID2 and deletes property “OS: OS-B.”

A program that executes each of the above steps on a computer that makes up the configuration management apparatus can be provided as a configuration management program. The above program is stored in a computer-readable storage medium so that the computer that makes up the configuration management apparatus can execute the program. The above computer-readable storage media include: an internal storage device installed in a computer, such as a ROM or RAM; a portable storage medium, such as a CD-ROM, flexible disk, DVD disk, magnetic optical disk or IC card; a data base that stores computer programs; and another computer and a database thereof.

Incidentally, a processing request acquisition unit corresponds to the operation execution unit 1 of the present embodiment. A linking unit corresponds to the processing execution unit 3 of the present embodiment. An attribute information reflection unit corresponds to the delay calculation determination unit 4, calculation execution unit 5 and delay calculation plan unit 6 of the present embodiment.

It is possible to make the processing time look shorter for a user by getting attribute information reflected in a configuration item at a different timing from a timing when a processing request is acquired.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention.

1. A configuration management apparatus that manages, on the basis of data having configuration items that are information representing resources that make up a system and attribute information defining the configuration items, information about the resources, comprising:
a processing request acquisition unit that acquires a processing request that at least includes attribute information and processing information about which process, registration, update or deletion of the attribute information, is to be performed;
a linking unit that determines, when a processing request is acquired by the processing request acquisition unit, for which configuration item the processing request is made and links the configuration item and the processing request; and
an attribute information reflection unit that performs a process of processing information inside the processing request for the configuration item on the basis of the linking by the linking unit at a different timing from a timing when the processing request is acquired by the processing request acquisition unit to get attribute information inside the processing request reflected in the configuration item.

2. The configuration management apparatus according to claim 1, wherein:
the processing request acquisition unit also acquires a retrieval process request of information about the resources as the processing information;
when the processing request acquisition unit acquires the retrieval process request and when there is unreflected attribute information among attribute information of a configuration item for which the retrieval process request is made, the attribute information reflection unit also gets the unreflected attribute information reflected on the basis of the linking by the linking unit.

3. The configuration management apparatus according to claim 1, wherein:
the processing request acquisition unit also acquires a desired completion time that is when an acquired processing request is to be completed; and
the attribute information reflection unit gets attribute information inside the processing request reflected in the configuration item by the desired completion time.

4. The configuration management apparatus according to claim 1, wherein
on the basis of the frequency of update of a configuration item related to attribute information inside the processing request, the attribute information reflection unit also makes a determination as to whether to get the attribute information inside the processing request reflected in the configuration item.

5. The configuration management apparatus according to claim 1, further comprising
a retaining unit that retains at least the configuration item and the attribute information, wherein
the attribute information reflection unit also makes a determination as to whether to get attribute information inside the processing request reflected in the configuration item on the basis of a period during which a configuration item related to the attribute information inside the processing request is retained in the retaining unit.

6. The configuration management apparatus according to claim 1, further comprising
a retaining unit that retains at least the configuration item and the attribute information, wherein
the attribute information reflection unit also makes a determination as to whether to get attribute information inside the processing request reflected in the configuration item on the basis of the data size of the attribute information inside the processing request.

7. The configuration management apparatus according to claim 6, wherein
the attribute information reflection unit also makes a determination as to whether to get attribute information inside the processing request reflected in the configuration item on the basis of the ratio of the data size of the attribute information inside the processing request and the available retaining capacity of the retaining unit.

8. A computer readable, non-transitory medium having recorded thereon a configuration management program that causes a computer to execute, on the basis of data having configuration items that are information representing resources that make up a system and attribute information defining the configuration items, registration, update, deletion and retrieval of information about the resources, the program causing the computer to execute a process comprising:
acquiring a processing request that at least includes attribute information and processing information about which process, registration, update or deletion of the attribute information, is to be performed;
determining, when a processing request is acquired, for which configuration item the processing request is made and linking the configuration item and the processing request; and
performing a process of processing information inside the processing request for the configuration item on the basis of the linking at a different timing from a timing when the processing request is acquired to get attribute information inside the processing request reflected in the configuration item.

9. The computer readable, non-transitory medium according to claim 8, wherein the process further comprises:
acquiring a retrieval process request of information about the resources as the processing information;
when the retrieval process request is acquired and when there is unreflected attribute information among attribute information of a configuration item for which the retrieval process request is made, getting the unreflected attribute information reflected on the basis of the linking.

10. The computer readable, non-transitory medium according to claim 8, wherein the process further comprises:
acquiring a desired completion time that is when an acquired processing request is to be completed; and
getting attribute information inside the processing request reflected in the configuration item by the desired completion time.

11. The computer readable, non-transitory medium according to claim 8, wherein the process further comprises:
on the basis of the frequency of update of a configuration item related to attribute information inside the processing request, making a determination as to whether to get the attribute information inside the processing request reflected in the configuration item.

12. The computer readable, non-transitory medium according to claim 8, wherein the process further comprises:
making a determination as to whether to get attribute information inside the processing request reflected in the configuration item on the basis of a period during which a configuration item related to the attribute information inside the processing request is retained in a retaining unit that retains at least the configuration item and the attribute information.

13. The computer readable, non-transitory medium according to claim 8, wherein the process further comprises:
making a determination as to whether to get attribute information inside the processing request reflected in the configuration item on the basis of the data size of the attribute information inside the processing request.

14. The computer readable, non-transitory medium according to claim 13, the process further comprises:
making a determination as to whether to get attribute information inside the processing request reflected in the configuration item on the basis of the ratio of the data size of the attribute information inside the processing request and the available retaining capacity of a retaining unit that retains at least the configuration item and the attribute information.

15. A configuration management method implemented in an apparatus that executes, on the basis of data having configuration items that are information representing resources that make up a system and attribute information defining the configuration items, registration, update, deletion and retrieval of information about the resources, the method comprising:
acquiring a processing request that at least includes attribute information and processing information about which process, registration, update or deletion of the attribute information, is to be performed;
determining, when a processing request is acquired, for which configuration item the processing request is made and linking the configuration item and the processing request; and
performing a process of processing information inside the processing request for the configuration item on the basis of the linking at a different timing from a timing when the processing request is acquired to get attribute information inside the processing request reflected in the configuration item.

16. The configuration management method according to claim 15, wherein:
acquiring a retrieval process request of information about the resources as the processing information;
when the retrieval process request is acquired and when there is unreflected attribute information among attribute information of a configuration item for which the retrieval process request is made, getting the unreflected attribute information reflected on the basis of the linking.

17. The configuration management method according to claim 15, wherein:
acquiring a desired completion time that is when an acquired processing request is to be completed; and
getting attribute information inside the processing request reflected in the configuration item by the desired completion time.

18. The configuration management method according to claim 15, wherein
on the basis of the frequency of update of a configuration item related to attribute information inside the processing request, making a determination as to whether to get the attribute information inside the processing request reflected in the configuration item.

19. The configuration management method according to claim 15, wherein
making a determination as to whether to get attribute information inside the processing request reflected in the configuration item on the basis of a period during which a configuration item related to the attribute information inside the processing request is retained in a retaining unit that retains at least the configuration item and the attribute information.

20. The configuration management method according to claim 15, wherein
making a determination as to whether to get attribute information inside the processing request reflected in the configuration item on the basis of the data size of the attribute information inside the processing request.

21. A configuration management apparatus that manages information related to resources constituting a system, comprising:
a memory configured to store data including configuration items that are information representing the resources and attribute information defining the configuration items; and
a processor coupled to the memory, wherein the processor executes a process comprising:
acquiring a processing request that at least includes attribute information and processing information about which process, registration, update or deletion of the attribute information, is to be performed;
determining, when a processing request is acquired by the acquiring, for which configuration item the processing request is made and links the configuration item and the processing request; and
performing a process of processing information inside the processing request for the configuration item on the basis of the linking by the determining at a different timing from a timing when the processing request is acquired by the acquiring to get attribute information inside the processing request reflected in the configuration item.
